(19) United States
(12) Patent Application Publication
(10) Pub. No.: US 2020/0095477 A1
(43) Pub. Date: Mar. 26, 2020

(54) ADHESIVE TAPE WITH SHAPED PEEL TAB AND METHOD FOR PRODUCING SUCH TAPE

(71) Applicant: tesa SE, Norderstedt (DE)

(72) Inventors: Wilhelm WATZKE, Hamburg (DE); Kevin KÜHNE, Hamburg (DE)

(73) Assignee: tesa SE, Norderstedt (DE)

(21) Appl. No.: 16/575,982

(22) Filed: Sep. 19, 2019

(30) Foreign Application Priority Data
Sep. 21, 2018 (DE) 10 2018 216 112.7

(51) Int. Cl. C09J 7/40; C09J 7/38

(52) U.S. Cl. CPC C09J 7/403; C09J 7/38; C09J 2400/225; C09J 2400/28; C09J 7/401

(57) ABSTRACT

Adhesive tapes and methods comprise an adhesive composition and a release material. One adhesive tape may have a release material comprising a peel tab region and an adhesive composition region, the adhesive composition region may bear the applied adhesive composition, the adhesive tape may extend along a lengthwise direction of the adhesive tape, and the peel tab region may extend perpendicularly to the lengthwise direction of the adhesive tape. The one adhesive tape may be configured in such a way that the extent of the peel tab region along the lengthwise direction varies.

This application claims foreign priority benefit under 35 U.S.C. § 119 of German Application No. 10 2018 216 112.7 filed Sep. 21, 2018.

The present invention relates to an adhesive tape having a release material and a peel tab region shaped therefrom for removing the release material. Furthermore, the invention relates to an adhesive tape utility and to a method for producing an adhesive tape of this kind with shaped peel tab region.

Adhesive tapes exist in a multiplicity of embodiments and variants. They have running lengths of a few 10 m up to 30 000 m. The widths of adhesive tapes are customarily between 10 mm and 30 mm, although other widths are manufactured. Generally speaking, an adhesive tape consists of a carrier and at least one adhesive composition applied thereon. However, there are also adhesive tapes without carriers.

At the end of the manufacturing process, adhesive tapes coated on one or both sides with adhesives are usually wound up into a roll in the form of an Archimedean spiral. With double-sided adhesive tapes, to prevent the adhesive compositions coming into contact with one another, or to prevent sticking of the adhesive composition to the carrier in the case of single-sided adhesive tapes, the adhesive tapes before being wound are applied to a release material (also referred to as cover material), which is wound up together with the adhesive tape. To the skilled person, release materials of these kinds are also known under the name of release liners, or simply liners. As well as for the covering of single-sided or double-sided adhesive tapes, liners are also used for enclosing labels.

In the manual or mechanical processing of adhesive tapes with release material, a problem which frequently exists is that the release material is not simple to detach from the adhesive tape for the latter to be bonded. One reason for this is that both the adhesive tape and the release material are very thin. Typical thicknesses of adhesive tapes and release materials are in the range from 10 μm to 1 mm, and hence the cut edge of an adhesive tape offers little purchase for the release material to be removed in one go as and when required. Another reason is that the often very flexible and rubber-like adhesive composition also makes it certain that at the cut edges of the adhesive tape, there is virtually no gap between adhesive composition and release material that might allow a finger, finger nail or tool to be engaged or hooked under.

To facilitate lifting of the release material, it is possible for the release material to be made wider than the adhesive composition, thus forming a peel tab, also called fingerlift, at the margin perpendicular to the lengthwise direction of an adhesive tape.

From DE 10 2014 110 218 A1 it is known that a release ply can be provided with a peel tab in order to assist the removal of a release ply from a base tape layer.

US 2017/0266066 A1 describes a fingerlift which facilitates the peeling and removal of an adhesive tape coated with adhesive composition on one side. In that case a rectangular tab is formed, which is intended to facilitate grasping. The adhesive tape plus peel tab may also be mounted as a roll or on a spool.

A disadvantage with the prior art is that for adhesive tapes with release material on which a peel tab is configured, there is increased rejection of adhesive composition and possibly carrier material at the manufacturing stage.

Another disadvantage in the prior art is that in the processing of adhesive tapes featuring release material with peel tab, a large quantity of waste arises as a result of the release material. The release material is peeled from the adhesive composition shortly before the application of the adhesive tape, and then has no further use.

In view of these disadvantages on the part of the prior art, the resources needed for manufacture are increased. In terms of manufacturing, as a result, adhesive tapes with peel tab are, furthermore, also less cost-effective to manufacture than adhesive tapes without peel tab.

It is an object of the present invention, therefore, to provide adhesive tapes with peel tab for which rejects of material during manufacture are reduced and for which the quantity of waste during processing is reduced.

This object is achieved by means of an adhesive tape which comprises a peel tab region, as recorded in the main claim.

The object of the invention is further achieved by an adhesive tape utility and also by a method for producing an adhesive tape of this kind.

A subject of the invention accordingly is an adhesive tape comprising an adhesive composition and a release material, where
the release material comprises a peel tab region and an adhesive composition region, and
the adhesive composition region bears the applied adhesive composition, and
where the adhesive tape extends along a lengthwise direction of the adhesive tape, and the peel tab region extends perpendicularly to the lengthwise direction of the adhesive tape,
characterized in that
the adhesive tape is configured in such a way that the extent of the peel tab region along the lengthwise direction varies.

For the purposes of the invention, adhesive tapes are understood to encompass all sheetlike structures such as two-dimensionally extended films or film sections, tapes with extended length and limited width, tape sections and the like, and lastly also die-cuts or labels. An adhesive tape for the purposes of the invention may have been furnished with an adhesive composition on one or both sides. Adhesive tapes typically have running lengths of a few 10 m up to 30 000 m. Customary widths of adhesive tape rolls or adhesive tape spools are 10, 15, 19, 25 and 30 mm. Other running lengths and adhesive tape widths also exist, however, and are not excluded from the teaching according to the invention. The adhesive tape may be in the form of a roll, in other words in the form of an Archimedean spiral rolled up onto itself, or may have been wound onto a spool element.

An adhesive composition in the sense of the invention may comprise an adhesive based on natural rubber, synthetic rubber or acrylate. Other adhesives as well, however, may be used. The adhesive composition may additionally comprise substances besides the adhesive, such as, for example, chemical or mechanical stabilizers, colour pigments, fibres, granules, phosphorescent substances, substances with medical activity or medicaments, magnetic or magnetizable particles, or other substances able to condition the properties of the adhesive composition. In particular, an adhesive composition also encompasses a pressure-sensitive adhesive composition.

An adhesive composition region for the purposes of the invention is intended to refer to a region in which adhesive composition has been or is applied.

A release material for the purposes of the invention is understood as a material which is applied to an adhesive composition and partly or fully covers that composition. The release material is indeed intended to attach to the adhesive composition, but not to enter into any intimate—that is, substance-to-substance—adhesive bond with it, hence allowing the release material, on use of the adhesive tape, to be removed as far as possible without residue and to be peeled off as far as possible with simplicity. Release materials may consist of various materials. Of preferential suitability as release material are non-linting materials which enter into no substance-to-substance bond with the adhesive composition.

A peel tab region in the sense of the teaching according to the invention refers to a region which forms a peel tab made of release material. In particular, a peel tab region bears no adhesive composition. The peel tab region is formed of release material which overhangs the adhesive composition, on one side of the adhesive composition or on two sides, for example. The overhanging release material may in that case also overhang only partly or in sections.

The peel tab region facilitates the manual or mechanical removal of the release material and is configured in such a way as to offer sufficient purchase for the release material to be grasped very easily by fingers or at least lifted with a finger nail, in order to allow the release material to be subsequently grasped, to then be peeled from the adhesive composition, or to provide a mechanical device with sufficient purchase to lift off the release material reliably.

A lengthwise direction of the adhesive tape refers to that direction in which an adhesive tape is customarily unwound. Generally speaking, this direction is determined by the elongate extent of the adhesive tape. In the case of adhesive tape sections or adhesive tape shapes whose section or shape is shorter than the width of the adhesive composition region, the lengthwise direction of the adhesive tape is defined by the shorter extent of the section or shape. Sections or shapes are to be taken to include die-cuts or labels.

An extent in the sense of the teaching according to the invention is intended to refer to an extension in a particular direction, more particularly the idea that a material or a region extends or continues in a certain direction. An extent per se has no defined shape here; however, it may describe a defined shape or contour.

The adhesive tape of the invention may be advantageously developed in that the extent varies undulatingly or semicircularly or triangularly or rectangularly or serratedly or trapezoidally or sinusoidally or varies in a combination of at least two of these forms.

These profiles are advantageous because they permit a reduction in the amount of material needed to form the peel tab regions, allowing it to be halved in particular in comparison to linear peel tab regions. The aforesaid profiles more particularly are profiles which can be described in a simple way by mathematical functions. This makes it easier to manufacture and set up separating tools, to set up manufacturing machinery, and to forecast and quantify production and rejects.

It is possible, furthermore, for at least one peel tab region to comprise holes; for example, holes may have been punched into the peel tab regions. With these holes it is possible in certain applications to improve the transport of an adhesive tape in manufacturing machines and/or dispensers. Conveying rolls in that case have corresponding teeth, which engage into the holes and convey the adhesive tape through a manufacturing machine or a dispenser. This kind of conveying technology is also known as “tractor conveying” and has the advantage of precise transport of the adhesive tape.

These profiles of the extent may also be advantageous in that they may serve for the marking and differentiation of adhesive tape products. Through different shaping of the peel tab regions it is possible, for example, for adhesive tape products to be differentiated visually from one another and, where appropriate, even for conclusions to be drawn about the type of adhesive tape.

It may further be preferable for the aforesaid profiles to be combined. For example, the profile may have a first form in a first section and, in a second section adjoining the first section, may have a second profile along the lengthwise direction of the adhesive tape. For example, a first section several centimetres long may have a semicircular profile, and an adjoining second section may then have a triangular profile. This may be advantageous since it already allows optical differentiation of the type of adhesive tape, meaning that different adhesive tapes are not easily confused. This may be advantageous in the case of processing on production lines, in car production or electronics production, for example, since it enables an improvement in the quality of the respective end products.

The adhesive tape of the invention may be developed by the extent varying continuously. The term “continuously” is intended to refer to a uniform variation. In particular it is intended to mean that there are no points of discontinuity in a mathematical sense. As described earlier on, release materials comprise films or papers. These are, by definition, thin and in some cases tear quickly as soon as excessive forces act on the material. In that case, moreover, it is common for not only the release material on the adhesive tape to tear, but instead for the tear to propagate into the adhesive composition and the carrier, where present, as well. This may result in the adhesive composition and the carrier, where present, swelling or forming edges, meaning that the thickness of the adhesive tape is no longer uniform. Such dimensional discrepancies may lead to a multiplicity of problems (sticking in a machine, complete tearing of the adhesive tape, slipping from transport rollers, etc.), especially in the case of semi-automatic or fully automatic processing of adhesive tapes, using dispensers, for example, and may then lead to considerable delays in production and assembly operations. In the case of manual assembly, as well, the dimensional integrity of an assembly operation may be affected by instances of swelling or edge formation. Moreover, a partly torn or torn carrier is no longer in general able to accommodate the tensile and shearing forces for which it has been specified and tested.

Tearing occurs in particular at acute and right angles. At obtuse angles as well, however, tears may be formed. Tears form in particular at points in which a release edge has a discontinuous profile.

To avoid the aforesaid problems, provision may be made, in accordance with the invention, for the extent to vary continuously, since in that case no corners are formed and therefore tearing of the release material can be avoided. This may also be done, for example, by the rounding of apexes and corners, in other words a rounding of the profile. Such rounding may have a defined radius, for example, of the kind also known from construction technology.

To reduce the tendency towards tearing, it is also possible for a release material to be used which already per se has a low tendency towards tearing. Possible examples of such release materials include those made of high-density polyethylene (HDPE, PEHD) or else composite materials of polypropylene and polyethylene. A material of this kind may of course also have the above rounded profile, to lower further the tendency towards tearing.

One possible development of the adhesive tape of the invention is that the extent varies periodically along the longitudinal axis. This is advantageous since it allows the production of the adhesive tape to be simplified and the production to take place more efficiently. For example, disc-shaped knives, such as roller knives, or cylindrical slitting knives may be used, with at least one cutter formed on their periphery, this cutter being able to generate at least one period of the periodic extent. This makes it possible, in particular, to have relatively high production rates, since periodic profiles of this kind can be produced using rotary tools such as rolls and cylinders, and the generation of the shaped peel tab region is possible in a particularly time-efficient manner. In general, suitability for this purpose is possessed by all commercial cutting, slitting or die-cutting processes which possess sufficient precision. Moreover, laser light may also be used. Particularly preferred is the use of rotating squeeze-cutting knives, as known from EP 1 829 948 A2.

In another possible development of the adhesive tape according to the invention, the release material additionally comprises a further peel tab region, which is configured opposite to the peel tab region. It may be advantageous for an adhesive tape to comprise a further peel tab region in order, for example, to allow the release material to be lifted on both sides. This may be an advantage in the case, for example, of assembly locations which are difficult to access. In that case the further peel tab region is preferably formed of the same release material as the peel tab region.

Another possible development of the adhesive tape of the invention is that the release material is a polymeric film. This polymeric film consists preferably of polyethylene terephthalate (PET), polypropylene (PP), polyethylene (PE) or rigid polyethylene (HDPE or PEHD), also known to the skilled person as high-density polyethylene or polyethylene high-density. Preference may also be given to monoaxially oriented polymeric films of polypropylene, also known to the skilled person as MOPP, or of monoaxially oriented polyethylene. It is likewise possible to employ composite materials, made of polypropylene (PP) and polyethylene (PE), for example. Release papers, however, are also suitable material for the release material. These release papers are frequently silicone-containing papers or sized long-fibre papers. Non-siliconized materials may also be employed as release material. These release materials have the advantage that they do not enter into any intimate or substance-to-substance bond with the adhesive composition, instead merely attaching to it. As a result, they can be peeled easily and without residue from an adhesive composition.

These materials, moreover, even in a very thin state, have sufficient tensile and tear strength to be used as a release material. It may be particularly preferred to use rigid polyethylene (HDPE or PEHD) as release material, since this material has particularly high tear strength.

It may also be preferable for the release material to have a release material adhesive composition at least on one side of a polymeric film or of a release paper. This may be advantageous in order to prevent a wound adhesive tape slipping or a spool unwinding.

In a possible advantageous development of the adhesive tape of the invention, the extent of the peel tab region is at most less than or equal to 25 mm, preferably less than or equal to 15 mm, more preferably less than or equal to 10 mm, more preferably still less than or equal to 5 mm, more preferably still less than or equal to 3 mm. It may be advantageous for the extent at most to have a certain length. This makes it possible, for example, to ensure that the peel tab region does not protrude further than a certain width over the adhesive composition, to prevent the peel tab regions being bent or folded or even torn or torn off by mechanical exposure from the outside. Accordingly, adverse effects such as poorer manual or mechanical processability can be avoided. The adhesive composition and any carrier present are also protected from tears in this way (cf. previous comments regarding tearing).

In a possible advantageous development of the adhesive tape of the invention, the extent of the peel tab region is at least greater than 0 mm, preferably greater than or equal to 10 mm, more preferably greater than or equal to 5 mm, more preferably still greater than or equal to 3 mm, more preferably still greater than or equal to 0.5 mm. It may be advantageous for the extent to have at least a small length. The result is a consistent peel tab region along the lengthwise direction on the adhesive composition. As a result, a minimum extent or offset in the peel tab region is formed. The advantage of this is that along the adhesive tape at every length it is possible to lift the release material, since at least a small part of the peel tab region protrudes beyond the adhesive composition.

In a possible development of the adhesive tape of the invention, the adhesive tape is a two-sidedly adhesively configured adhesive tape, having an upper and a lower adhesive composition, and at least the upper or the lower adhesive composition is lined with the release material, or the upper and the lower adhesive compositions are lined with an upper and a lower release material. Depending on application, single-sided or double-sided adhesive tapes are required. In the case of double-sided adhesive tapes with two adhesive compositions, it may be advantageous for at least one or both adhesive compositions to be lined with a release material, in which case a peel tab or peel tabs is/are configured on the release material.

Furthermore, in a possible development of the adhesive tape of the invention, the adhesive composition has a width of 3 mm to 40 mm, preferably 4 mm to 30 mm, more preferably 5 mm to 25 mm, more preferably 6 mm to 15 mm.

Moreover, in a possible development of the adhesive tape of the invention, the adhesive tape comprises a carrier, where at least part of the adhesive composition is disposed between the carrier and the release material, more particularly such that the carrier bears the applied adhesive composition, and/or the carrier is embedded in the adhesive composition. This may be advantageous because an adhesive tape with a carrier is able to absorb higher tensile and shearing forces. Moreover, tearing and tear propagation are reduced advantageously by a carrier. In this case the carrier is disposed on the adhesive composition; for example, the carrier may bear the applied adhesive composition. More preferably the carrier consists of polypropylene (PP), monoaxially oriented polypropylene (MOPP), biaxially oriented polypropylene (BOPP), polyvinyl chloride (PVC), polyethylene terephthalate (PET), nonwovens, polyethylene (PE), foams of polyethylene or else foams of acrylate.

The carrier may also be completely embedded in the adhesive composition, so that the carrier is a reinforcing element surrounded by a matrix of adhesive composition. Examples of this are fibre-reinforced adhesive tapes or adhesive tapes with nonwoven carriers. Lastly, preference may also be given to a combination of both the aforesaid alternatives—that is, a carrier which partly is embedded in the adhesive composition and partly protrudes from the adhesive composition.

Furthermore, in a possible development of the adhesive tape of the invention, the adhesive tape comprises a further release material, where the further release material comprises a further adhesive composition region, and where the further adhesive composition region bears the applied adhesive composition. Particularly in the case of double-sidedly configured adhesive tapes, it may be advantageous if a further release material is provided which may have the aforesaid properties and forms of development of the release material. With a further release material it is possible in particular to line both adhesive compositions of a double-sided adhesive tape.

Moreover, in a possible development of the adhesive tape of the invention, the further release material may comprise a further peel tab region. The aforesaid development of an adhesive tape by a further release material can also be continued advantageously by configuration of a further peel tab region in the further release region. In that case the further peel tab region is to be able to have the aforesaid properties and forms of development of the peel tab region. The eventual result, then, is at least two adhesive composition regions whose adhesive compositions are lined with in each case one release material. In that case the release material and the further release material can be removed independently of one another. This may have advantages if double-sided adhesive tapes, for example, are converted beforehand, by production of shapes, for example, and these shapes are intended for processing only at a later point in time. In the course of transport and storage, the adhesive composition regions are lined and the adhesive compositions are protected from instances of contamination or from sticking.

Furthermore, the object of the invention is achieved by an adhesive tape utility comprising a plurality of adhesive tapes,
which in each case are configured according to one of the preceding versions, where
the respective lengthwise directions of the adhesive tapes are disposed parallel to one another,
   and a first adhesive tape having a first peel tab region and a second adhesive tape having a second peel tab region are disposed in such a way that the first peel tab region and the second peel tab region border one another.

The object of the invention is further achieved in that in the case of the aforesaid adhesive tape utility, the first peel tab region and the second peel tab region reciprocally engage into one another.

An adhesive tape utility for the purposes of the present invention is intended to mean a rectangular or square sheet from which, by separation or extraction of individual regions, at least one adhesive tape is generated, and more particularly from which, by separation or extraction of regions, an adhesive tape of the invention is generated. An adhesive tape utility may also be understood to be a rectangular or square utility which is wound up into a spool or wound up on a roll, said utility including, for example, a jumbo roll or a parent roll. An adhesive tape utility of this kind preferably already comprises the release material, bearing the applied adhesive composition.

As a result of this arrangement of two adhesive tapes of the invention on an adhesive tape utility, the utility can be exploited particularly efficiently. The reason for this is that the first and second peel tab regions vary in their extent along the lengthwise directions of the first and second adhesive tapes. Hence it is possible for the first peel tab region and the second peel tab region to be configured reciprocally. Reciprocally here means that, if the extent of the first peel tab region increases, the extent of the second peel tab region reduces. With more particular preference, the sum total of the width of the extent of the first peel tab region and the width of the extent of the second peel tab region is constant along the lengthwise direction of the adhesive tape. When this is the case, the maximum amount of release material can be saved.

Where the profiles of the peel tab regions vary periodically, the reciprocal configuration of the peel tab regions may also be interpreted as a phase shift or phase offset between the profiles of the two extents. In the version according to the invention, the shift in the two periodic profiles amounts to 180° or half a period. In the geometrical sense, this corresponds to a mirroring or an inversion of the periodic profiles of the extents.

The aforesaid arrangement of the adhesive tapes on an adhesive tape utility has the advantage, furthermore, that two adjacent adhesive tapes can be positioned more closely to one another through the reciprocal configuration of the peel tab regions. Consequently, with an unchanged size or width of an adhesive tape utility, it is possible to manufacture significantly more adhesive tapes from one adhesive tape utility. This leads, consequently, to a significantly more efficient utilization of the materials employed, and also to a reduction in the manufacturing costs. It also thus allows more adhesive tapes to be manufactured in the same time.

Furthermore, the object of the invention is achieved by a method for producing adhesive tapes, comprising the steps of:
a) providing an adhesive tape precursor, where the adhesive tape precursor comprises at least one release region which is configured on a release material and which is free from adhesive composition,
b) separating in the release region in such a way that a first peel tab region of a first release material of a first adhesive tape of the adhesive tapes is generated and a second peel tab region of a second release material of a second adhesive tape of the adhesive tapes is generated, where
more particularly a first adhesive tape and a second adhesive tape are formed according to any of claims 1 to 12.

In this context, an adhesive tape precursor is understood to be a partly processed adhesive tape utility on which previous processing steps have already been carried out, such as, for example, the trimming of edges or the application of a passivating layer. For the method of the invention it is preferred for at least one release region which no longer comprises any adhesive composition to already have been configured on an adhesive tape precursor. For this purpose, adhesive composition can be removed from the release material, or simply no adhesive composition can even be applied to the release material beforehand.

In a further step, the adhesive tape precursor is then separated within the release region. Separation is intended to refer in accordance with the invention to the cutting or die-cutting of a material by means of a separating tool. A separating tool is any device allowing the release material to be separated. The devices in question may be devices with rotating or rotary knives, cutting dies, circular knives or doctor knives. Likewise, a separating tool may also be a die-cutting tool. Of general suitability for this purpose are all commercial cutting, slitting or die-cutting processes which possess sufficient precision. In any case, laser light can also be used. Particular preference is given to the use of rotating squeeze-cutting knives, as are known from EP 1 829 948 A2.

The separation takes place preferably such as to generate the adhesive tapes described above.

In a possible advantageous development of the method of the invention, preparatory to the step a), in a step a′), parent adhesive composition which is applied on a parent release material is structured in such a way that at least one release region is exposed and an adhesive tape precursor is generated, more particularly in such a way that a plurality of release regions are exposed and an adhesive tape utility is generated.

In accordance with the teaching of the invention, a parent release material means a release material in the form of a web which is unworked and has merely its original form. A parent adhesive composition means an original application of an adhesive composition to a material, in this case a parent release material.

The exposing of the at least one release region may be accomplished, for example, by doctor knives or by parting and lifting the adhesive composition to be removed. This may be advantageous since in that case in step b) a peel tab region can be generated, and a step for lifting the adhesive composition of the release material of which the peel tab region is formed, for exposure, can be omitted. The latter would be much more complicated to achieve, because the profile of the peel tab region varies along the lengthwise direction of the adhesive tape. In general, moreover, versions are preferred in which the smallest extent of the peel tab region is 0 mm. In such a case it would then be necessary for individual, non-contiguous, die-cut or cut sections of adhesive composition to be removed from the parent release material. That would be possible only with very great effort, thereby illustrating by way of example the advantage of step a′).

With particular preference, a plurality of release regions are exposed and hence an adhesive tape utility having a plurality of release regions is provided. In this way it is also possible simultaneously to manufacture a plurality of adhesive tapes.

The method of the invention may advantageously be developed in that preparatory to step a) or a′), in a step a″), a parent adhesive composition is applied to a parent release material.

This preparatory step may be part of the method of the invention. In that case the adhesive tape utility is provided by step a″) in the wider sense.

The method of the invention may also be continued in that preparatory to step a), in a step a′″), adhesive composition is applied to a parent release material in such a way as to form release regions. Alternatively to the preceding version, it may be preferable to apply adhesive composition in stripes to a parent release material. The profiles of these stripes may vary as mentioned earlier on, namely varying semicircularly or triangularly or rectangularly or serratedly or trapezoidally or sinusoidally, or in a profile corresponding at least to a combination of two of these forms.

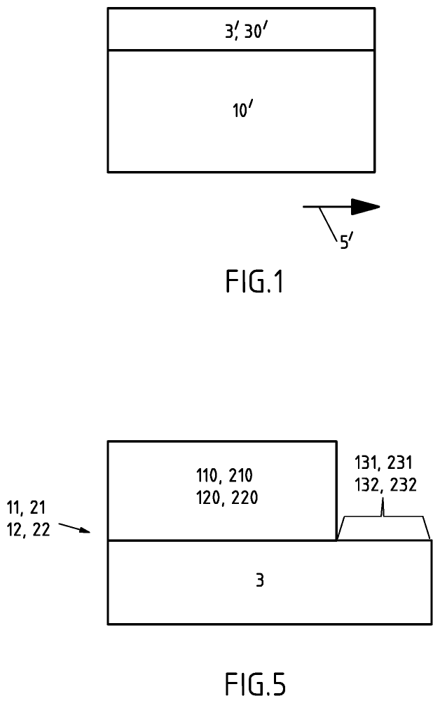

Exemplary embodiments are represented in FIG. 1 to FIG. 7M, in which:

FIG. 1: shows an adhesive tape with peel tab region according to the prior art.

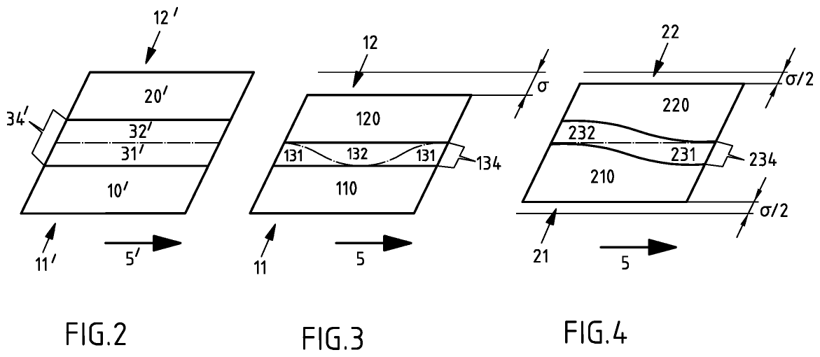

FIG. 2: shows an adhesive tape with peel tab region according to the prior art (in different representation).

FIG. 3: shows an exemplary embodiment of the inventive adhesive tape according to a first variant.

FIG. 4: shows an exemplary embodiment of the inventive adhesive tape according to a second variant.

FIG. 5: shows a cross section through the cut edge of an inventive adhesive tape.

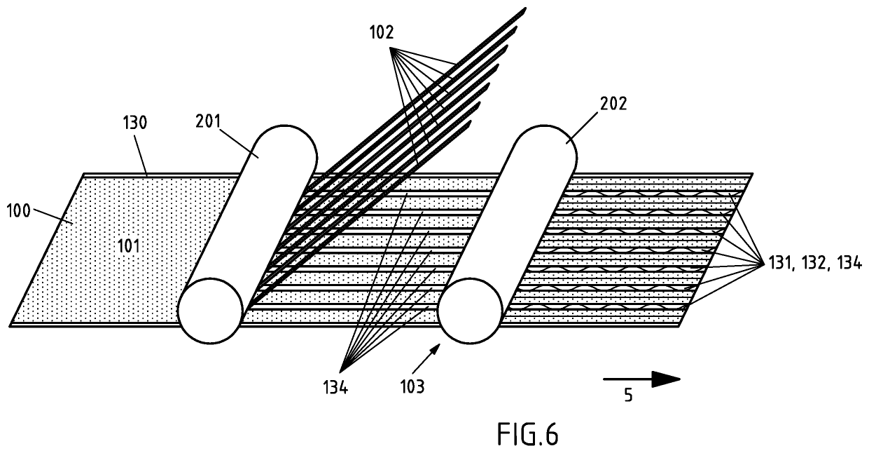

FIG. 6: shows an exemplary production method for a plurality of adhesive tapes with a varying peel tab region.

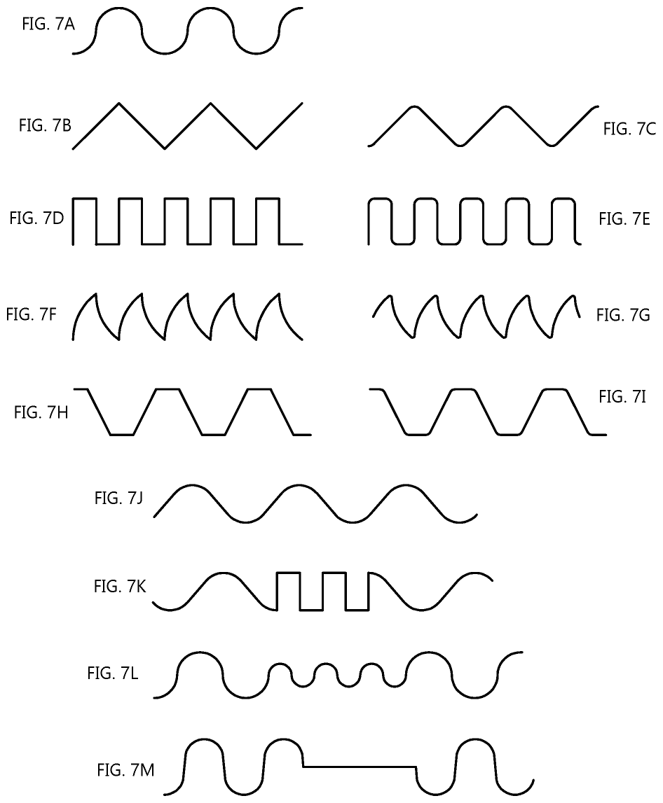

FIG. 7A: a semicircular profile.

FIG. 7B: a triangular profile.

FIG. 7C: a rounded triangular profile.

FIG. 7D: a rectangular profile.

FIG. 7E: a rounded rectangular profile.

FIG. 7F: a serrated profile.

FIG. 7G: a rounded serrated profile.

FIG. 7H: a trapezoidal profile.

FIG. 7I: a rounded trapezoidal profile.

FIG. 7J: a sinusoidal profile.

FIG. 7K: a profile with sectionally combined sinusoidal and rectangular profile.

FIG. 7L: a profile with sectionally different semicircular profiles.

FIG. 7M: a profile with sectionally sinusoidal and linear profile.

FIG. 1 represents a schematic plan view of an adhesive tape according to the prior art. Configured on a release material 3′ is an adhesive composition region 10′ with adhesive composition. Configured on the release material 3′ is also a peel tab region 30′. Since the width of the adhesive composition region is smaller than that of the release material, the peel tab region 30′ is formed. Since in the lengthwise direction of the adhesive tape 5′ there is no variation either in the width of the adhesive composition region 10′ or in the width of the peel tab region 30′, the contours of adhesive composition region 10′ and peel tab region 30′ run parallel.

FIG. 2 represents a perspective detail of two adhesive tapes 11′, 12′ without shaped peel tab regions 31′, 32′. The adhesive composition regions 10′, 20′ are applied on the release material. A release region 34′ is free from adhesive composition. The lengthwise direction of the adhesive tape is specified with reference numeral 5′.

FIG. 3 is represented on the same scale as FIG. 2 and represents a perspective detail of two inventive adhesive tapes 11, 12 with two reciprocally configured peel tab regions 131, 132 and two adhesive composition regions 110, 120. In this case, two adhesive tapes 11, 12 are each arranged parallel to one another along their respective lengthwise directions 5. Moreover, the peel tab regions 131, 132 of the first and second adhesive tapes 11, 12 border one another.

The profiles of the peel tab regions 131, 132 are in varying configurations in the case of the inventive adhesive tapes. The profile of the extent of a peel tab region 131, 132 varies sinusoidally along the lengthwise direction 5 of the inventive adhesive tapes 11, 12. The sinusoidal profile of the first peel tab region 131 and the sinusoidal profile of the second peel tab region 132 exhibit a phase offset of 180° or half a period in this case.

The reciprocal configuration of the peel tab regions 131, 132 means that the required width of the release region 134 is reduced to half by comparison with an adhesive tape without shaped peel tab region. In this case the width δ saved amounts to just the maximum extent of a peel tab region 131, 132, and hence in the example to the amplitude of the sinus profile.

FIG. 4 is represented on the same scale as FIGS. 2 and 3 and represents a perspective detail of an inventive adhesive tape 21, 22 according to a second embodiment with two reciprocally configured peel tab regions 231, 232 and two adhesive composition regions 210, 220. In this case, two adhesive tapes 21, 22 are each arranged parallel to one another along their respective lengthwise directions 5. Moreover, the peel tab regions 231, 232 of the first and second adhesive tapes 21, 22 border one another.

The profiles of the adhesive composition regions 210, 220 are in varying configurations in the case of the inventive adhesive tapes. The profile of the extent of an adhesive composition region 210, 220 varies sinusoidally along the lengthwise direction 5 of the inventive adhesive tapes 21, 22. The sinusoidal profile of the first adhesive composition region 210 and the sinusoidal profile of the second adhesive composition region 220 exhibit a phase offset of 180° or half a period in this case.

The reciprocal configuration of the adhesive composition regions 210, 220 means that the required width of the release regions 234 is reduced to half by comparison with an adhesive tape without shaped peel tab region. In this case the width saved amounts to just the maximum extent of a peel tab region 231, 232, and hence in the example to the amplitude of the sinus profile. This width saving is divided in FIG. 3 in equal parts between the upper region with δ/2 and the lower region of the adhesive tape with δ/2.

FIG. 5 represents schematically the production method for the inventive adhesive tapes. Here, a multiplicity of identical adhesive tapes are produced in parallel. The starting material 100 comprises the parent release material 130 and the parent adhesive composition 101, and is worked on by a first separating unit 201 having a squeeze-cutting knife. In this case, the parent adhesive composition 101 is cut into, but not the underlying parent release material 130. As a result, by means of doctor blades or other peeling means, for example, strips of adhesive composition 102 can be lifted from the release material, and the adhesive tape precursor 103 can be provided. The lifted adhesive composition can then be used further in order to provide further starting material. The adhesive tape precursor then has release regions 134 within which the parent release material is later separated. The lifted strips 102 are rejects.

In a second separating unit 202, within the release regions 134, the peel tab regions 131, 132 are formed, by the separating unit 202 cutting the parent release material 130. This may be done by means of one of the aforementioned separation methods, preferably with a squeeze-cutting knife. In this separating process, the varying extent of the peel tab regions 131, 132 is also formed, and is sinusoidal, for example. The tools of the separating unit 202 here describe the profile of the peel tab regions 131, 132.

Moreover, the separating unit 202 may separate the adhesive composition region 110, 120 together with the parent release material 130 below it, thus providing a multiplicity of adhesive tapes.

With the appropriate adaptations, this production method may also be employed analogously for producing adhesive tapes according to the second embodiment.

FIG. 6 represents a schematic cross section of an adhesive tape 11, 12, 21, 22. In this case the adhesive tape is disposed in such a way that the lengthwise direction of the adhesive tape emerges from and recedes into the plane of the image. On a release material 3, the adhesive composition region 110, 120, 210, 220 and the peel tab region 131, 132, 231, 232 are configured.

FIGS. 7A-7F, by way of example and not exhaustively, represent a number of preferred profiles of extents of peel tab regions. They show the following:
FIG. 7A semicircular profile
FIG. 7B triangular profile
FIG. 7C rounded triangular profile
FIG. 7D rectangular profile
FIG. 7E rounded rectangular profile
FIG. 7F serrated profile
FIG. 7G rounded serrated profile
FIG. 7H trapezoidal profile
FIG. 7I rounded trapezoidal profile
FIG. 7J sinusoidal profile
FIG. 7K profile with sectionally combined sinusoidal and rectangular profile
FIG. 7L profile with sectionally different semicircular profiles
FIG. 7M profile with sectionally sinusoidal and linear profile

### Comparative Experiment

The potential of this invention can be illustrated by way of example by comparing the materials requirement for adhesive tapes with non-shaped peel tab region with the materials requirement of adhesive tapes produced with the inventive method. The examples which follow start from a parent roll having a parent roll width B_{M} of 1 m. The width of the adhesive composition region B_{K} varies in Examples 1-3 between 10 mm and 20 mm. Similarly, the width of the peel tab region B_{A} varies between 4 mm and 8 mm. Because of the inventive reciprocally configured peel tab regions of the inventive adhesive tapes, it is possible to manufacture considerably more adhesive tapes per adhesive tape utility and to save on release material. In particular, in the case of the parallel arrangement of a plurality of adhesive tape rolls on one adhesive tape utility, the required width of the peel tab region B_{A} is halved relative to an unshaped peel tab region. The examples also assume that no minimal fingerlift is provided. The effective total width B_{G} of an adhesive tape is obtained from the width of the adhesive composition region B_{K} and the width of the peel tab region B_{A}. This width is the width which an individual adhesive tape has on average (arithmetic mean) over the total running length of a parent roll. For the inventive adhesive tapes, therefore, there is a halving on average in the width of the required peel tab region. Depending on the parameters B_{K} and B_{A}, different effective total widths B_{Geff} result for an individual adhesive tape on the parent roll, and hence there is also a difference in the number of adhesive tapes which can be manufactured from one parent roll.

On the basis of three examples, the table below represents on an exemplary basis the percentage increase in inventive adhesive tapes per parent roll, relative to adhesive tapes which do not have a shaped peel tab region.

| | B_{K} | B_{A} | B_{Geff} | N_{K} | Δ |
|---|---|---|---|---|---|
| | [mm] | [mm] | [mm] | [—]* | [%] |
| Example 1: | | | | | |
| Non-shaped peel tab | 20 | 4 | 24 | 41 | — |
| region | | | | | |
| Shaped peel tab region | 20 | 4 | 22 | 45 | 9.7 |
| Example 2: | | | | | |
| Non-shaped peel tab | 14 | 6 | 20 | 50 | — |
| region | | | | | |
| Shaped peel tab region | 14 | 6 | 17 | 58 | 16.0 |
| Example 3: | | | | | |
| Non-shaped peel tab | 10 | 8 | 18 | 55 | — |
| region | | | | | |
| Shaped peel tab region | 10 | 8 | 14 | 71 | 29.1 |

*The width of the parent roll, B_{M}, in Examples 1 to 3 is always 1 m.

B_{M} width of parent roll
B_{K} width of adhesive composition region
B_{A} width of peel tab region
B_{Geff} effective total width of adhesive tape on the parent roll
N_{K} number of adhesive tape rolls per parent roll
Δ percentage materials saving per mother roll from the use of the inventive adhesive tapes relative to non-shaped peel tab region

The three examples illustrate that with the inventive adhesive tapes it is possible to make a considerable saving on material, or that the material which is used is utilized much more efficiently. Because of the halving in the effective width of the peel tab region, there is also a halving in the rejects in the form of lifted adhesive composition, essentially. This also relates to the materials requirement for forming the peel tab region. As a result of the more efficient utilization of material, it is also possible to produce more adhesive tapes from one parent roll.

### LIST OF REFERENCE NUMERALS

11, 21 first adhesive tape
12, 22 second adhesive tape
3 release material
3′ release material
5 lengthwise direction of an adhesive tape
5′ lengthwise direction of an adhesive tape
10′ adhesive composition region
11′, 12′ first adhesive tape with non-shaped peel tab region
20′ adhesive composition region
30′ peel tab region
31′, 32′ non-shaped peel tab region
34′ release region
100 starting material
101 parent adhesive composition
102 lifted adhesive composition
103 adhesive tape precursor
110, 210 first adhesive composition region
120, 220 second adhesive composition region
130 parent release material
131, 231 peel tab region of the first adhesive tape
132, 232 peel tab region of the second adhesive tape
134, 234 release region
201 first separating unit
202 second separating unit

1. An adhesive tape comprising:
an adhesive composition; and
a release material,
wherein
the release material comprises a peel tab region and an adhesive composition region,
the adhesive composition region bears the applied adhesive composition,
where the adhesive tape extends along a lengthwise direction of the adhesive tape, and the peel tab region extends perpendicularly to the lengthwise direction of the adhesive tape, and
the adhesive tape is configured such that the extent of the peel tab region along the lengthwise direction varies.

2. The adhesive tape of claim 1, wherein the extent varies semicircularly or triangularly or rectangularly or serratedly or trapezoidally or sinusoidally or varies in a combination of at least two of these forms.

3. The adhesive tape of claim 1, wherein the extent varies continuously.

4. The adhesive tape of claim 1, wherein the extent varies periodically along the longitudinal axis.

5. The adhesive tape of claim 1, wherein the release material further comprises a further peel tab region, that is configured oppositely to the peel tab region.

6. The adhesive tape of claim 1, wherein the release material is a polymeric film or a release paper.

7. The adhesive tape of claim 1, wherein the extent of the peel tab region is at most less than or equal to 25 mm and the extent of the peel tab region is greater than or equal to 0.5 mm.

8. The adhesive tape of claim 1, wherein the adhesive composition region has a width of 3 to 40 mm.

9. The adhesive tape of claim 8, wherein the adhesive composition region has a width of 6 to 15 mm.

10. The adhesive tape of claim 1, wherein the adhesive tape comprises a carrier, wherein at least part of the adhesive composition is disposed between the carrier and the release material.

11. The adhesive tape of claim 10, wherein
the carrier bears the applied adhesive composition, and/or
the carrier is embedded in the adhesive composition.

12. The adhesive tape of claim 1, wherein the adhesive tape comprises a further release material, that comprises a further adhesive composition region, and the further adhesive composition region bears the applied adhesive composition.

13. The adhesive tape of claim 12, wherein the further release material comprises a further peel tab region.

14. An adhesive tape utility comprising a plurality of the adhesive tapes of claim 1,
wherein
the respective lengthwise directions of the adhesive tapes are disposed parallel to one another, and
a first adhesive tape having a first peel tab region and a second adhesive tape having a second peel tab region are disposed in such a way that the first peel tab region and the second peel tab region border one another.

15. The adhesive tape utility of claim 14, wherein the first peel tab region and the second peel tab region reciprocally engage in one another.

16. A method for producing adhesive tapes, the comprising:
a) providing an adhesive tape precursor, wherein the adhesive tape precursor comprises at least one release region that is configured on a release material and that is free from adhesive composition; and
b) separating in the release region in such a way that a first peel tab region of a first release material of a first adhesive tape of the adhesive tapes is generated and a second peel tab region of a second release material of a second adhesive tape of the adhesive tapes is generated,
wherein
the first adhesive tape and the second adhesive tape comprise the adhesive tape of claim 1.

17. The method of claim 16, wherein preparatory to a), in an a′), parent adhesive composition (101) which is applied on a parent release material (130) is structured in such a way that at least one release region (134, 234) is exposed and an adhesive tape precursor (103) is generated, more particularly in such a way that a plurality of release regions (134, 234) are exposed and an adhesive tape precursor (103) is generated.

18. The method of claim 16, wherein preparatory to a) or a′), in an a″), a parent adhesive composition is applied to a parent release material.

19. The method of claim 18, wherein preparatory to a), in an a′″), adhesive composition is applied to a parent release material in such a way as to form release regions.
